(19) United States
(12) Patent Application Publication
(10) Pub. No.: US 2015/0221902 A1
(43) Pub. Date: Aug. 6, 2015

(54) GASKET FOR A SECONDARY BATTERY AND A SECONDARY BATTERY

(71) Applicant: SANYO ELECTRIC CO., LTD., Osaka (JP)

(72) Inventors: Yuji Otake, Osaka (JP); Keisuke Shimizu, Osaka (JP)

(73) Assignee: SANYO ELECTRIC CO., LTD., Osaka (JP)

(21) Appl. No.: 14/424,324

(22) PCT Filed: Sep. 26, 2012
(86) PCT No.: PCT/JP2012/006134

§ 371 Date: Feb. 26, 2015

(51) Int. Cl. H01M 2/08; H01M 10/04

(52) U.S. Cl. CPC H01M 2/08; H01M 10/0431

(57) ABSTRACT

A gasket for a secondary battery is provided between a battery casing and a sealing body for sealing the opening of the battery casing. The gasket for the secondary battery includes at least two insulating layers composed of a first insulating layer, which is a surface layer on a battery casing side, and a second insulating layer, which is disposed nearer the sealing body than the first insulating layer. The melting point of a first material constituting the first insulating layer is higher than that of a second material constituting the second insulating layer.

### TECHNICAL FIELD

The present invention relates to a gasket for a second battery, and a secondary battery including said gasket for the secondary battery.

### BACKGROUND TECHNOLOGY

The conventional secondary battery (cell) or rechargeable battery (hereinafter simply referred to as “battery” or “cell” also) is configured as follows. That is, an electrode group, where a cathode plate and an anode plate with a separator disposed therebetween are wound, is contained in a battery casing together with an electrolytic solution. On a lateral surface of the battery casing, there is formed a recess which is recessed toward the interior of the battery casing. A sealing body is provided above the recess by way of a gasket. An opening end of the battery casing is swaged to a periphery of the sealing body by way of the gasket. An opening of the battery casing is sealed off by the sealing body in a manner such that the gasket is placed between the battery casing and the sealing body. The gasket electrically insulates between the sealing body and the battery casing.

In consideration of keeping up a sufficient hermeticity (airtightness) inside the battery casing, a sealant may be applied to an internal surface of the recess in the battery casing. If, however, an organic solvent is used as the electrolytic solution, the sealant may possibly dissolve when the electrolytic solution adheres to the sealant during the injection of the electrolytic solution. The dissolution of the sealant may cause the hermeticity to deteriorate. In contrast to this, Patent Document 1 discloses a technology where the gasket is constructed of at least two-layer structure comprised of a substrate resin layer and a surface resin layer in contact with the battery casing, so that the surface resin layer can function as a sealant layer.

### RELATED ART DOCUMENTS

### Patent Documents

[Patent Document 1] Japanese Unexamined Patent Application Publication No. 2008-204839.

In the aforementioned Patent Document 1, applying the sealant to a gasket side allows the application of the sealant in the internal surface of the recess to be skipped. This can avoid the aforementioned dissolution of the sealant resulting from the adhesion of the electrolytic solution and therefore can help maintain the hermeticity inside the battery casing.

Through their earnest and diligent research-and-development efforts under these circumstances, the inventors of the present invention have come to recognize that the durability of the conventional gaskets needs to be improved for the purpose of helping suppress a drop in performance of the battery.

The present invention has been made in view of foregoing circumstances, and a purpose thereof is to provide a technology for improving the durability of a gasket.

### Means for Solving the Problems

One embodiment of the present invention relates to a gasket for a secondary battery. The gasket for the secondary battery is provided between a battery casing and a sealing body for sealing an opening of the battery casing, the gasket for the secondary battery includes: at least two insulating layers of a first insulating layer, which is a surface layer on a battery casing side, and a second insulating layer, which is disposed nearer the sealing body than the first insulating layer, wherein a melting point of a first material constituting the first insulating layer is higher than that of a second material constituting the second insulating layer.

Another embodiment of the present invention relates to a secondary battery. The secondary battery includes: an electrode group where a cathode plate and an anode plate are wound together with a separator; a battery casing for housing the electrode group; a sealing body for sealing an opening of the battery casing; and a gasket for a secondary battery according to the above-described embodiment.

### Effect of the Invention

The present invention provides a technology for improving the durability of a gasket.

### BRIEF DESCRIPTION OF THE DRAWINGS

FIG. 1 is a cross-sectional view showing schematically a configuration of a secondary battery according to a first embodiment;

FIG. 2 is a perspective view showing schematically a structure of a gasket for a secondary battery according to a first embodiment;

FIG. 3 is a cross-sectional view showing schematically a structure of a gasket for a secondary battery according to a first embodiment;

FIG. 4 is a cross-sectional view showing schematically a structure of a gasket for a secondary battery according to a second embodiment; and

FIG. 5 is a cross-sectional view showing schematically a structure of a gasket for a secondary battery according to a modification.

### MODES FOR CARRYING OUT THE INVENTION

Hereinbelow, the embodiments will be described with reference to the accompanying drawings. Note that in all of the Figures the same reference numerals are given to the same components and the repeated description thereof is omitted as appropriate.

The inventors' knowledge underlying the present invention will be first explained before the embodiments of the present invention are explained. The inventors had found out that there are still problems to be solved as follows when used is a secondary battery in which the opening of a battery casing is sealed by a sealing body through a gasket. In other words, if the batteries (cells) are subjected to a high temperature environment as a result of ignition or the like occurring in adjacent cell(s), the gasket will be exposed to high temperature. The gasket disclosed in Patent Document 1 is formed of a resin material having the surface resin layer whose melting point is very low. As a result, an external surface of the gasket is more likely to be melted when the gasket is exposed to high temperature. As the external surface of the gasket melts, a gap or spacing is created between the battery casing and the gasket and thereby the electrolytic solution and gas inside the battery are leaked outside. This can possibly causes a drop in performance of the battery, for instance. Accordingly, improving the durability of the gasket, particularly improving the durability thereof when the gasket is subjected to a high temperature environment, is demanded.

### First Embodiment

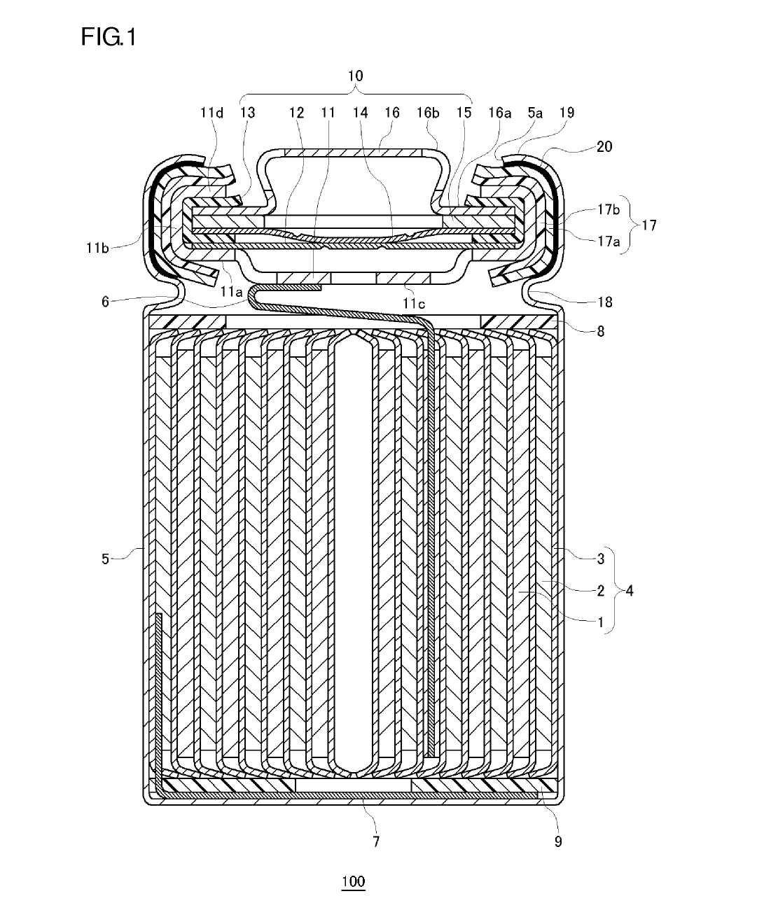

FIG. 1 is a cross-sectional view showing schematically a configuration of a secondary battery (secondary cell) according to a first embodiment. In the present embodiment, a description is given of a concrete example where a lithium-ion secondary battery is used as the secondary battery. A secondary battery 100 (secondary cell 100) according to the present embodiment includes an electrode group 4, a battery casing 5, a sealing body 10, and a gasket 17 for a secondary battery.

The electrode group 4 is structured such that a cathode plate 1 and an anode plate 2 are wound together with a separator 3. The cathode plate 1 and the anode plate 2 are wound with the separator 3 being held between the cathode plate 1 and the anode plate 2. The battery casing 5 is a retaining shield case that contains and houses the electrode group 4 therein. The electrode group or a group of electrodes 4 are contained in a cylindrical battery casing 5 together with the electrolytic solution. Though its detailed depiction is omitted in FIG. 1, the cathode plate 1 has a cathode current collector and a cathode mixture layer, which is formed on the cathode current collector and which contains a cathode active material. Also, the anode plate 2 has an anode current collector and an anode mixture layer, which is formed on the anode current collector and which contains an anode active material.

The cathode plate 1 is connected to a metallic plate 11, which is a constituent of the sealing body 10, by way of a cathode lead 6. The anode plate 2 is connected to a bottom of the battery casing 5 by way of an anode lead 7.

An insulating plate 8 is arranged on an upper end of the electrode group 4, namely on an end of an opening end 5a side of the battery casing 5 in the electrode group 4. On the other hand, an insulating plate 9 is arranged on a lower end of the electrode group 4, namely on an end of a bottom side of the battery casing 5 in the electrode group 4.

On a lateral surface of the battery casing 5, there is formed a recess 18 which is recessed toward the interior of the battery casing 5. The sealing body 10 is provided above the recess 18 by way of the gasket 17 for the secondary battery. The recess 18 prevents the sealing body 10 from moving or entering toward the electrode group 4 in a housing space of the battery casing 5. The opening end 5a of the battery casing 5 is swaged to a center side of the battery casing 5, namely a periphery side of the sealing body 10. In other words, a caulking portion 19 is formed at an upper end of the battery casing 5. The caulking portion 19 presses a periphery of the sealing body 10 downward through the gasket 17 for the secondary battery. An opening of the battery casing 5 is sealed off by the sealing body 10 with the gasket 17 for the secondary battery disposed between the battery casing 5 and the sealing body 10.

An upper portion of the battery casing 5 has the recess 18 and the caulking portion 19. Thus, the cross-sectional shape of the upper portion thereof is approximately C-shape or approximately U-shape. The sealing body 10 is held, between the recess 18 and the caulking portions 19, by way of the gasket 17 for the secondary battery and is secured to the battery casing 5. In this patent specification, the “caulking portion 19” indicates a portion that is bent when the battery casing 5 is swaged thereto. The battery casing 5 is bottomed cylindrical in shape before the recess 18 and the caulking portion 19 are formed. In order to increase the hermeticity inside the battery casing 5, a sealant layer 20 where a sealant such as bron agent is applied is provided in a region starting from the recess 18 to the caulking portion 19 along an inner surface of the battery casing 5.

The sealing body 10 is a member used to seal an opening of the battery casing 5. The sealing body 10 is comprised of a metallic plate 11, a first valve plate 12, an inner gasket 13, a second valve plate 14, a PTC (Positive Temperature Coefficient) element 15, and a cap 16. The metallic plate 11 is connected to the cathode plate 1 by way of the cathode lead 6. The first valve plate 12 is provided above the metallic plate 11. The second valve plate 14 is provided above the first valve plate 12. The inner gasket 13 is set between the first valve plate 12 and the second valve plate 14. The PTC element 15 having a circular shape is provided above the second valve plate 14. The PTC element 15 is an element having a positive temperature coefficient and is an element whose internal resistance increases as the temperature rises. The cap 16, which is provided above the PTC element 15, also serves as a cathode terminal.

In more detail, the metallic plate 11 has a disk portion 11a, which is in contact with a bottom surface of a periphery of the first valve plate 12, and a cylindrical portion 11b, which extends upward from an outer circumferential end of the disk portion 11a. The disk portion 11a has a protruding portion 11c that protrudes below a center part thereof, namely protrudes toward the bottom of the battery casing 5. A top surface of the disk portion 11a abuts against a periphery of the first valve plate 12. The cathode lead 6 abuts against the protruding portion 11c. An upper end of the cylindrical portion lib is swaged to a center side of the battery casing 5 and therefore the metallic plate 11 has a caulking portion 11d on its periphery thereof. The caulking portion 11d is swaged to a periphery of the cap 16 by way of the inner gasket 13 (i.e., the inner gasket 13 is positioned between the caulking portion 11d and the periphery of the cap 16). The cross-sectional shape of the caulking portion 11d is approximately L-shape. The cross-sectional shape of the periphery of the metallic plate 11, namely a portion constituted by the disk portion 11a, the cylindrical portion 11b and the caulking portion 11d, is approximately U-shape. Note that, in this patent specification, the “caulking portion 11d” indicates a portion that is bent when the cylindrical portion 11b is swaged thereto.

The first valve plate 12 and the second valve plate 14 have thin-walled parts where the thickness thereof is smaller. The first valve plate 12 and the second valve plate 14 are partially in contact with each other; more specifically, the first valve plate 12 and the second valve plate 14 abut against each other on a center side of the battery further than the thin-walled parts. The inner gasket 13 is set between a periphery of the first valve plate 12 and a periphery of the second valve plate 14. A central part of the first valve plate 12 and a central part of the second valve plate 14 abut against each other. The PTC element 15 abuts against a top surface of a periphery of the second valve plate 14.

The cap 16 has a flat peripheral portion 16a, which abuts against the PTC element 15, and a protruding portion 16b, which protrudes inside and above the peripheral portion 16a, namely protrudes toward an opening of the battery casing 5.

An outer surface of the inner gasket 13 abuts against a top surface of an periphery of the first valve plate 12 and inner surfaces of the cylindrical portion 11b and the caulking portion 11d. An inner surface of the inner gasket 13 abuts against a bottom surface and a lateral surface of a periphery of the second valve plate 14, a lateral surface of the PTC element 15, and a lateral surface and a top surface of the peripheral portion 16a. In other words, a periphery of the metallic plate 11 holds the first valve plate 12, the inner gasket 13, the second valve plate 14, the PTC element 15 and the cap 16. Thereby, the respective components are configured in an integrated manner.

The reasons why the sealing body 10 has the first valve plate 12, the inner gasket 13 and the second valve plate 14 are as follows. That is, the secondary battery 100 preferably has a function of cutting off the current flowing between the metallic plate 11 and the cap 16 if a gas is generated and a pressure inside the battery rises so as to exceed a predetermined pressure. In the light of this, the sealing body 10 has the thin-walled parts, which are breakable in the event that the pressure inside the battery exceeds the predetermined pressure, the first valve plate 12 and the second valve plate 14, which are in contact with each other at their central parts, and the inner gasket 13, which is set between the periphery of the first valve plate 12 and the periphery of the second valve plate 14. With this arrangement and configuration, the first valve plate 12 and the second valve plate 14 get separated away from each other if the thin-walled parts of the first valve plate 12 and the second valve plate 14 are broken or deformed. As a result, the current flowing between the metallic plate 11 and the cap 16, which are electrically connected through the first valve plate 12 and the second valve plate 14, can be cut off.

An opening through which to communicate with the exterior of the battery is formed in the cap 16. Also, an opening is formed in each of the metallic plate 11 and the insulating plate 8. When a gas is generated inside the battery and then the pressure inside the battery exceeds the predetermined pressure, the thin-walled parts of the first valve plate 12 and the second valve plate 14 are broken or deformed. As a result, the gas generated inside the battery is discharged to the exterior of the battery by passing through the opening of the insulating plate 8, the opening of the metallic plate 11, the broken part(s) of the first valve plate 12, the broken part(s) of the second valve plate 14 and the opening of the cap 16.

Thus, the sealing body 10 does not necessarily have the two valve plates and the inner gasket 13. For example, the sealing body 10 may have the metallic plate 11, the PTC element 15 arranged on the metallic plate 11, and the cap arranged on the PTC element 15.

The reasons why the sealing body 10 has the PTC element 15 are as follows. That is, the secondary battery 100 preferably has a function of cutting off the current flowing between the metallic plate 11 and the cap 16 if the temperature inside the battery exceeds a predetermined temperature. In the light of this, the sealing body 10 has the PTC element 15 (1) that is set between the cap 16 and the second valve plate 14 which is electrically connected to the metallic plate 11, and (2) whose internal resistance increases when the temperature inside the battery exceeds a predetermined temperature. With this arrangement and function, the current flowing between the second valve plate 14 and the cap 16 is cut off if the internal resistance of the PTC element 15 increases. As a result, the current flowing between the cap 16 and the metallic plate 11 which is electrically connected to the second valve plate 14, can be shut off.

Thus, the sealing body 10 does not necessarily have the PTC element 15. For example, the sealing body 10 may have the metallic plate 11, the first valve plate 12 arranged on the metallic plate 11, the second valve plate 14 arranged on the first valve plate 12, the cap 16 arranged on the second valve plate 14, and the inner gasket 13 set between the periphery of the first valve plate 12 and the periphery of the second valve plate 14.

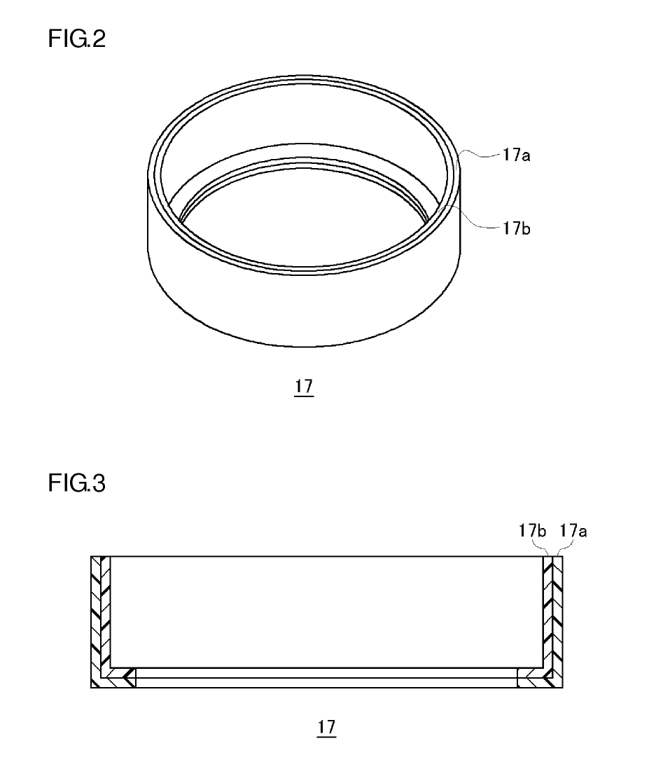

A detailed description is now given of a structure of the gasket 17 for the secondary battery. FIG. 2 is a perspective view showing schematically a structure of a gasket for a secondary battery according to the first embodiment. FIG. 3 is a cross-sectional view showing schematically a structure of a gasket for the secondary battery according to the first embodiment. Note that FIG. 2 and FIG. 3 each shows a state before an upper end of the gasket has been bent inward by the formation of the caulking portion 19.

The gasket 17 for the secondary battery is provided between the battery casing 5 and the sealing body 10 for sealing the opening of the battery casing 5. Also, the gasket 17 for the secondary battery is a member having not only a function of maintaining the hermeticity between the battery casing 5 and the sealing body 10 but also a function of preventing the short-circuiting between the battery casing 5 and the sealing body 10. The gasket 17 for the secondary battery, which is of a ring shape, is arranged between an upper portion of the battery casing 5 and a periphery of the metallic plate 11. An outer surface of the gasket 17 for the secondary battery abuts against an inner surface of the upper portion of the battery casing 5, and an inner surface of the gasket 17 for the secondary battery abuts against an outer surface of the periphery of the metallic plate 11. The gasket 17 for the secondary battery is located outside the inner gasket 13 and therefore constitutes an outer gasket. An upper end of the ring-shaped gasket 17 for the secondary battery is preferably located on a center side of the battery farther than the opening end 5a of the battery casing 5.

The gasket 17 for the secondary battery is so structured that it has a multiple layer formed of at least two layers. The gasket 17 for the secondary battery comprises a first insulating layer 17a, which constitutes a surface layer on a battery casing 5 side, and a second insulating layer 17b, which is disposed nearer the sealing body 10 than the first insulating layer 17a. Since the gasket 17 for the secondary battery according to the present embodiment is of a two-layer structure, the second insulating layer 17b constitutes a surface layer on a sealing body 10 side.

The first insulating layer 17a is formed of a first material whose melting point is higher than that of a second material constituting the second insulating layer 17b. The first material as used herein may be, for example, a fluorine contained resin (fluororesin), such as PFA (polytetrafluoroethylene-co-perfluoropropylvinylether; the melting point being about 350° C.) and PTFE (polytetrafluoroethylene; the melting point being about 320° C.), PPS (polyphenylene sulfide; the melting point being about 280° C.), PBT (polybutylene terephthalate; the melting point being about 230° C.), P1 (polyimide; no melting point) or the like. The melting point of the first material is preferably 250° C. or above and more preferably 300° C. or above.

The second material as used herein may be, for example, PP (polypropylene; the melting point being about 170° C.), PE (polyethylene; the melting point being about 130° C.), natural/synthetic rubber (the limit temperature of heat resistance: about 120° C. to about 200° C.) or the like.

Also, the hardness of the first insulating layer 17a is preferably lower than that of the second insulating layer 17b. In other words, it is preferable that the first insulating layer 17a is softer than the second insulating layer 17b and is more likely to be deformable. Thus, it is preferable that the melting point of the first material is higher than that of the second material and that the hardness of the first material is lower than that of the second material. For that reason, the first material is suitably a fluororesin. In the present embodiment, the thickness of the first insulating layer 17a is approximately equal to that of the second insulating layer 17b.

As described above, the gasket 17 for the secondary battery according to the present embodiment is structured such that the first insulating layer 17a, which constitutes the surface layer on a battery casing 5 side, is formed of the first material whose melting point is higher than that of the second material forming the second insulating layer 17b, which is arranged on a sealing body side. This can improve the durability of the gasket 17, for the secondary battery, against a high temperature environment. Accordingly, the gasket 17 for the secondary battery has a high durability. This can suppress the external surface of the gasket 17 for the secondary battery from being melted in the event that the secondary battery 100 is subjected to a high temperature environment and the gasket 17 for the secondary battery is exposed to high temperature. As a result, the leakage of the electrolytic solution and gas inside the battery can be avoided and therefore a drop in performance of the battery can be suppressed. Thus, the secondary battery 100 equipped with the gasket 17 for the secondary battery according to the present embodiment can maintain the satisfactory battery performance for a long period of time.

Also, the gasket 17 for the secondary battery has the first insulating layer 17a formed of the first material whose melting point is high. Thus, the short-circuiting between the battery casing 5 and the sealing body 10 can be prevented more reliably. Furthermore, the hardness of the first insulating layer 17a is lower than that of the second insulating layer 17b. This can suppress the gasket 17 for the secondary battery from suffering with cracks or being damaged in the event that the gasket 17 for the secondary battery is subject to a physically power shock from the outside. Also, when the secondary battery 100 is manufactured, more in detail, when the opening end 5a of the battery casing 5 is swaged to the periphery of the sealing body 10 by way of the gasket 17 for the secondary battery, the cracks occurring in or the damage to the gasket 17 for the secondary battery can be suppressed.

Also, a plurality of layers constituting the gasket 17 for the secondary battery are formed of different materials, respectively. Thus, the mechanical strength (e.g., the tensile strength, the Izod impact strength and the bending strength), the deterioration behavior by oxidation, hydrolysis and the like, the thermal expansion coefficient and so forth are different in the respective layers. Accordingly, the gasket 17 for the secondary battery is constituted by a plurality of layers each of which has a different characteristic from the other layers. Hence, the gasket 17 for the secondary battery can have higher impact resistance, higher degradation resistance and wider operating temperature range. Furthermore, the gasket 17 for the secondary battery has the second insulating layer 17b formed of the second material whose melting point is lower than that of the first material. Thus, the amount of high melting point material used can be reduced over a case where the gasket 17 for the secondary battery is constituted by the first insulating layer 17a only. As a result, an increase in the manufacturing cost of the gasket 17 for the secondary battery can be suppressed. Also, the specific gravities of PFA and PBT used as the first material are about 1.7 to about 2 and about 1.3, respectively, for instance, whereas the specific gravy of PP or rubber used as the second material is about 0.9, for instance. Thus, the gasket 17, for the secondary battery, provided with the second insulating layer 17b can be made lighter weight than the gasket, for the secondary battery, constituted by the first insulating layer 17a alone. This can help reduce the weight of the secondary battery 100 and, in particular, a secondary battery module equipped with a plurality of such secondary batteries 100 can significantly reduce the overall weight of the module.

### Second Embodiment

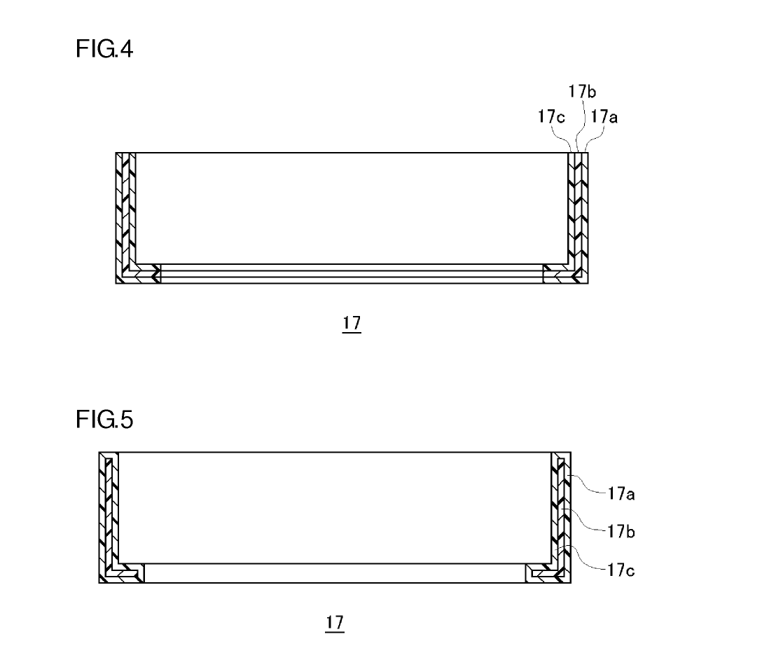

A gasket for a secondary battery according to a second embodiment shares the same structure as that of the gasket for the secondary battery according to the first embodiment, excepting that the gasket according to the second embodiment includes a third insulating layer. The structure of the secondary battery is identical to that of the secondary battery according to the first embodiment except for the gasket for the secondary battery. A description is hereinbelow given of the gasket for the secondary battery as well as the secondary battery according to the second embodiment by centering around different features from the first embodiment. FIG. 4 is a cross-sectional view showing schematically a structure of a gasket for a secondary battery according to the second embodiment.

A gasket 17 for a secondary battery according to the second embodiment further comprises a third insulating layer 17c, which constitutes a surface layer on a sealing body 10 side, in addition to the first insulating layer 17a and the second insulating layer 17b. Thus, the gasket 17 for the secondary battery is configured such that the second insulating layer 17b is interposed between the first insulating layer 17a and the third insulating layer 17c.

The third insulating layer 17c is formed of a third material whose melting point is higher than that of is the second material. The same material as the first material may be used for the third material. Similar to the first material, the melting point of the third material is preferably 250° C. or above and more preferably 300° C. or above, too. Similar to the first insulating layer 17a, the hardness of the third insulating layer 17c is preferably lower than that of the second insulating layer 17b and therefore the third material is suitably a fluororesin. In the present embodiment, the thicknesses of the first insulating layer 17a, the second insulating layer 17b and the third insulating layer 17c are approximately equal to each other.

As described above, the gasket 17 for the secondary battery according to the present embodiment is structured such that the third insulating layer 17c, which constitutes the surface layer on a sealing body 10 side, is formed of the third material whose melting point is higher than that of the second material. This can further improve the durability of the gasket 17, for the secondary battery, against a high temperature environment and therefore can further suppress a drop in performance of the battery. Also, the short-circuiting between the battery casing 5 and the sealing body 10 can be prevented more reliably. Also, the cracks occurring in or the damage to the gasket 17 for the secondary battery can be further suppressed. Furthermore, the gasket 17 for the secondary battery can have higher impact resistance, higher degradation resistance and wider operating temperature range.

(Modification)

The second embodiment may encompass or further include a modification as follows, for instance. FIG. 5 is a cross-sectional view showing schematically a structure of a gasket for a secondary battery according to the modification. A gasket 17 for a secondary battery according to the present modification is configured such that the first insulating layer 17a and the third insulating layer 17c are integrally formed with each other. In other words, an end of the first insulating layer 17a and an end of the third insulating layer 17c are coupled together on an end surface of the second insulating layer 17b.

In this modification, the second insulating layer 17b in its entirety is covered with the first insulating layer 17a and the third insulating layer 17c. This arrangement and structure can prevent the second insulating layer 17b, whose melting point is low, from being exposed to the exterior, thereby further improving the durability of the gasket 17 for the secondary battery. The gasket 17 for the secondary battery can be formed by an insert molding, for instance. In other words, the surface of the second insulating layer 17b is covered with a high melting point material with a pre-formed second insulating layer 17b being used as the core, so that the gasket 17 for the secondary battery, where the second insulating layer 17b is covered with the first insulating layer 17a and the third insulating layer 17c, can be produced.

The present invention is not limited to the above-described embodiments only. It is understood that various modifications such as changes in design may be made based on the knowledge of those skilled in the art, and the embodiments added with such modifications are also within the scope of the present invention.

In the above-described first embodiment, second embodiment and modification, the sealing body 10 is comprised of the metallic plate 11, the first valve plate 12, the inner gasket 13, the second valve plate 14, the PTC element 15, and the cap 16, and is configured such that the periphery of the metallic plate 11 is swaged to the periphery of the cap 16 by way of the inner gasket 13. However, the structure and arrangement of the sealing body 10 are not limited thereto. For example, the sealing body 10 may not be configured such that the periphery of the metallic plate 11 is swaged to the periphery of the cap 16 by way of the inner gasket 13

In the above-described first embodiment, second embodiment and modification, a description has been given of a concrete example where the lithium-ion secondary battery is used as the secondary battery. However, the embodiments and the modification of the present invention are not limited thereto. Also, the gasket 17 for the second battery may be constructed of four or more layers and, for example, another insulating layer may be provided between the first insulating layer 17a and the third insulating layer 17c.

The features and characteristics of the present invention described based on the above-described embodiments may be defined by the following Item 1 to Item 7:

### [Item 1]

In a gasket for a secondary battery, which is provided between a battery casing and a sealing body for sealing an opening of the battery casing, the gasket for the secondary battery including:

at least two insulating layers comprised of a first insulating layer, which is a surface layer on a battery casing side, and a second insulating layer, which is disposed nearer the sealing body than the first insulating layer,

wherein the melting point of a first material constituting the first insulating layer is higher than that of a second material constituting the second insulating layer.

### [Item 2]

The gasket for the secondary battery according to Item 1, wherein the melting point of the first material is 300° C. or above.

### [Item 3]

The gasket for the secondary battery according to Item 1 or Item 2, wherein the first material is a fluororesin.

### [Item 4]

The gasket for the secondary battery according to any one of Item 1 to Item 3, wherein the hardness of the first insulating layer is lower than that of the second insulating layer.

### [Item 5]

The gasket for the secondary battery according to any one of Item 1 to Item 4, further including a third insulating layer that is a surface layer on a sealing body side,

wherein the melting point of a third material constituting the third insulating layer is higher than that of the second material.

### [Item 6]

A secondary battery including:

an electrode group where a cathode plate and an anode plate are wound together with a separator;

a battery casing for housing the electrode group;

a sealing body for sealing an opening of the battery casing; and

a gasket for a secondary battery according to any one of Item 1 to Item 5.

### [Item 7]

The secondary battery according to Item 6, further including a sealant layer provided in an internal surface of the battery casing.

### DESCRIPTION OF THE REFERENCE NUMERALS

1 Cathode plate

2 Anode plate

3 Separator

4 Electrode group

5 battery casing

10 Sealing body

17 Gasket for a secondary battery

17a First insulating layer

17b Second insulating layer

17c Third insulating layer

100 Secondary battery

### INDUSTRIAL APPLICABILITY

The present invention can be used for a gasket for a secondary battery and a secondary battery.

1. A gasket for a secondary battery, which is provided between a battery casing and a sealing body for sealing an opening of the battery casing, the gasket for the secondary battery including:
at least two insulating layers of a first insulating layer, which is a surface layer on a battery casing side, and a second insulating layer, which is disposed nearer the sealing body than the first insulating layer,
wherein a melting point of a first material constituting the first insulating layer is higher than that of a second material constituting the second insulating layer.

2. The gasket for the secondary battery according to claim 1, wherein the melting point of the first material is 300° C. or above.

3. The gasket for the secondary battery according to claim 1, wherein the first material is a fluororesin.

4. The gasket for the secondary battery according to claim 1, wherein hardness of the first insulating layer is lower than that of the second insulating layer.

5. The gasket for the secondary battery according to claim 1, further including a third insulating layer that is a surface layer on a sealing body side,
wherein the melting point of a third material constituting the third insulating layer is higher than that of the second material constituting the second insulating layer.

6. A secondary battery including:
an electrode group where a cathode plate and an anode plate are wound together with a separator;
a battery casing for housing the electrode group;
a sealing body for sealing an opening of the battery casing; and
a gasket for a secondary battery according to any one of claim 1 to claim 5, which is provided between the battery casing and the sealing body.

7. The secondary battery according to claim 6, further including a sealant layer provided in an internal surface of the battery casing.
